(19) United States
(12) Patent Application Publication
(10) Pub. No.: US 2009/0278073 A1
(43) Pub. Date: Nov. 12, 2009

(54) POLYMERIC MEA FOR FUEL CELL

(75) Inventors: Ki Yun Cho, Seoul (KR); In Chul Hwang, Gyeonggi-do (KR); Dong Il Kim, Incheon (KR); Ju Ho Lee, Incheon (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); DONGJIN SEMICHEM CO., LTD., Gyeonggi-do (KR)

(21) Appl. No.: 12/272,964

(22) Filed: Nov. 18, 2008

(30) Foreign Application Priority Data
May 8, 2008 (KR) 10-2008-0043030

(51) Int. Cl. H01G 9/028

(52) U.S. Cl. 252/62.2

(57) ABSTRACT

A polymeric electrolyte membrane for a polymer electrolyte membrane fuel cell comprises: (a) a sulfonated polysulfoneketone copolymer comprising an aromatic sulfone repeating unit, an aromatic ketone repeating unit and an aromatic compound repeating unit which connects said repeating units with an ether linkage, wherein the aromatic sulfone repeating unit, the aromatic ketone repeating unit or both have a sulfonic acid or sulfonate substituent; and (b) one or more polymers each comprising a monomer selected from the group consisting of vinylidene fluoride, hexafluoropropylene, trifluoroethylene and tetrafluoroethylene.

### CROSS-REFERENCE TO RELATED APPLICATION

This application claims under 35 U.S.C. §119(a) the benefit of Korean Patent Application No. 10-2008-0043030 filed May 8, 2008, the entire contents of which are incorporated herein by reference.

### BACKGROUND

1. Technical Field

The present invention relates to a polymeric electrolyte membrane for a polymer electrolyte membrane fuel cell (PEMFC) with improved membrane/electrode interfacial stability.

2. Background Art

With the recent rapid advance of information and communications technology and development of various products, technologies related with mobile electronic devices, such as mobile phones, notebook computers, personal digital assistants (PDAs), digital cameras, camcorders, etc., are growing rapidly. The development of the technologies related with mobile electronic devices has led to the advent of highly functionalized mobile electronic devices for satisfying the consumers' needs for more information. However, the highly functionalized mobile electronic devices consume a lot of energy and are restricted in use for a long period of time. Consequently, the apparatuses that supply energy to these devices are becoming critical in determining the performance of the electronic devices.

A fuel cell is an electrochemical energy conversion device. It produces electricity from fuel and an oxidant. At the anode (or fuel electrode) side, oxidation of the fuel occurs, and, at the cathode (or oxygen electrode) side, reduction of oxygen occurs. The basic structure of a fuel cell is membrane-electrode assembly (MEA) consisting of a fuel electrode and an oxygen electrode with catalysts embedded therein respectively and an electrolyte membrane positioned therebetween. In the MEA, the electrolyte membrane functions to transfer protons from the fuel electrode to the oxygen electrode through catalytic action and as a barrier that prevents the fuel from being directly mixed with oxygen. At present, Nafion, a perfluorinated polymer having excellent hydration stability and superior proton conductivity, is commonly used as an electrolyte membrane for a PEMFC. However, Nafion is expensive, has undesirable dimensional stability, and exhibits decreased proton conductivity at high temperature (80° C.). Further, when directly applied for a methanol fuel cell, it shows high permeability to methanol. These disadvantages make the polymer difficult to be commercially applicable.

For this reason, development of new hydrocarbon-based proton conducting materials that can be used at high temperature and have relatively low methanol permeability are carried out actively, in order to replace the perfluorinated polymer Nafion. Typical examples of such polymeric electrolyte membrane materials include polyimide, polyetheretherketone, polyethersulfone, polybenzimidazole, and the like. However, these alternative materials show low proton conductivity and low membrane/electrode interface stability as well as undesirable dimensional stability because of high water content upon hydration. Accordingly, there is a need for a new membrane material to improve cell performance and long-term stability.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention provides a polymeric electrolyte membrane which comprises: (a) a sulfonated polysulfoneketone copolymer comprising an aromatic sulfone repeating unit, an aromatic ketone repeating unit and an aromatic compound repeating unit which connects said repeating units with an ether linkage, wherein the aromatic sulfone repeating unit, the aromatic ketone repeating unit or both have a sulfonic acid or sulfonate substituent; and (b) one or more polymers each comprising a monomer selected from the group consisting of vinylidene fluoride, hexafluoropropylene, trifluoroethylene and tetrafluoroethylene.

Preferably, the polymer may be comprised in the amount of 0.01-50.weight % based on the sulfonated polysulfoneketone copolymer.

In a preferred embodiment, the aromatic sulfone repeating unit may be represented by the following Chemical Formula 1, the aromatic ketone repeating unit may be represented by the following Chemical Formula 2, the aromatic compound repeating unit which connects said repeating units with an ether linkage may be represented by the following Chemical Formula 3, the aromatic sulfone repeating unit having a sulfonic acid or sulfonate group may be represented by the following Chemical Formula 4, and the aromatic ketone repeating unit having a sulfonic acid or sulfonate group may be represented by the following Chemical Formula 5:

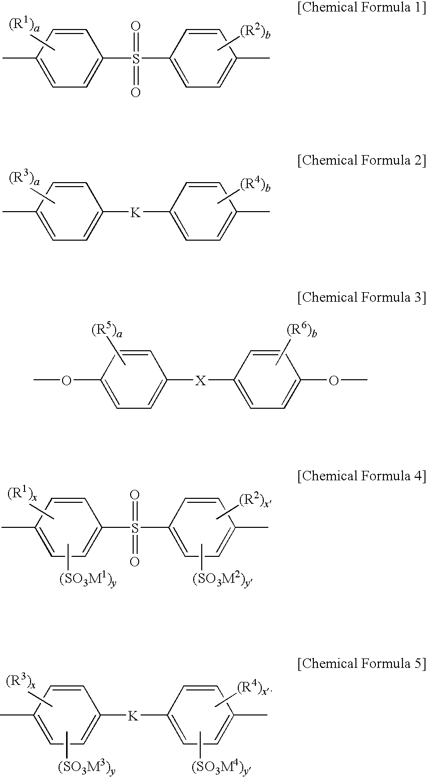

where

each of M¹, M², M³ and M⁴ is independently selected from the group consisting of hydrogen, sodium, lithium and potassium,

K is a ketone selected from the group consisting of —CO—, —CO—CO— and

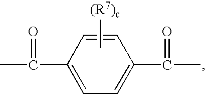

X is selected from the group consisting of —O—, —S—, —NH—, —SO₂—, —CO—, —C(CH₃)₂— and —C(CF₃)₂—,

each of R¹, R², R³, R⁴ and R⁵ is independently selected from the group consisting of a C₅-C₃₀ aromatic ring and a C₁-C₃₀ alkyl substituent containing a heteroatom selected from oxygen, nitrogen and sulfur,

each of a, b and c is independently an integer from 0 to 4,

each of x and x′ is independently an integer from 0 to 3,

each of y and y′ is independently an integer from 1 to 4, and

each of (x+y) and (x′+y′) is independently an integer from 1 to 4.

In another preferred embodiment, the polysulfoneketone copolymer may have a molecular structure represented by the following Chemical Formula 6 or Chemical Formula 7:

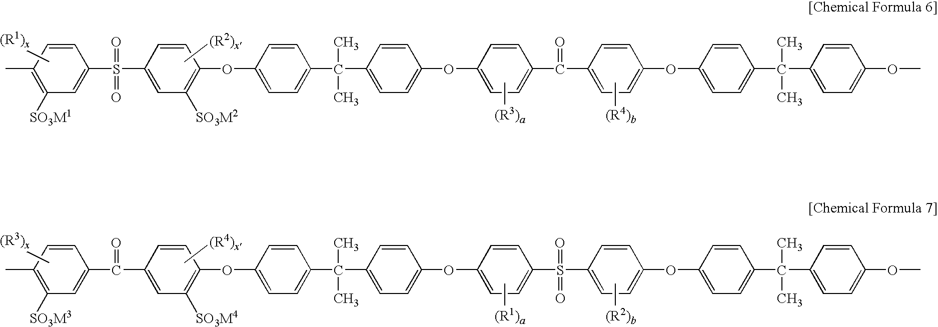

where

each of R¹, R², R³ and R⁴ is independently selected from the group consisting of a C₅-C₃₀ aromatic ring and a C₁-C₃₀ alkyl substituent containing a heteroatom selected from oxygen, nitrogen and sulfur,

each of M¹, M², M³ and M⁴ is independently selected from the group consisting of hydrogen, sodium, lithium and potassium,

each of a and b is independently an integer from 0 to 4, and

each of x and x′ is independently an integer from 0 to 3.

As described above, the polymeric electrolyte membranes for a PEMFC according to the present invention are prepared by introducing a material with good compatibility to a sulfonated hydrocarbon-based polymer material having low fuel permeability and superior proton conductivity. The polymeric electrolyte membrane show improved membrane/electrode interface adhesion and membrane/electrode interface stability, thereby making it possible to ensure long-term stability of a hydrocarbon-based polymeric MEA.

The above and other aspects and features of the present invention will be discussed in detail infra.

### BRIEF DESCRIPTION OF THE DRAWINGS

The above and other objects, features and other advantages of the present invention will be more clearly understood from the following detailed description taken in conjunction with the accompanying drawings, in which:

FIG. 1 shows proton conductivity of the polymeric electrolyte membranes prepared in Examples 1 through 5;

FIG. 2 shows dimensional stability of the polymeric electrolyte membranes prepared in Examples 1 through 5;

FIG. 3 shows long-term stability of the polymeric electrolyte membrane prepared in Example 1;

FIG. 4 shows long-term stability of the polymeric electrolyte membrane prepared in Comparative Example 1;

FIG. 5 shows long-term stability of the polymeric electrolyte membrane prepared in Example 1;

FIG. 6 shows long-term stability of the polymeric electrolyte membrane prepared in Comparative Example 2; and

FIG. 7 shows SEM images of the cross-sections of polymeric MEAs prepared in Example 1 and Comparative Example 2.

### DETAILED DESCRIPTION

Hereinafter reference will now be made in detail to various embodiments of the present invention, examples of which are illustrated in the accompanying drawings and described below.

One aspect of the present invention provides a polymeric electrolyte membrane comprising: (a) a sulfonated polysulfoneketone copolymer comprising an aromatic sulfone repeating unit, an aromatic ketone repeating unit and an aromatic compound repeating unit which connects said repeating units with an ether linkage, wherein the aromatic sulfone repeating unit, the aromatic ketone repeating unit or both have a sulfonic acid or sulfonate substituent; and (b) one or more polymers each comprising a monomer selected from the group consisting of vinylidene fluoride, hexafluoropropylene, trifluoroethylene and tetrafluoroethylene.

Suitably, the sulfonated polysulfoneketone copolymer may comprise an aromatic sulfone repeating unit, an aromatic ketone repeating unit and an aromatic compound repeating unit which connects said repeating units with an ether linkage. The aromatic sulfone repeating unit, the aromatic ketone repeating unit, or both may have a sulfonic acid or sulfonate group. Preferable examples of the polymer comprises a monomer selected from vinylidene fluoride, hexafluoropropylene, trifluoroethylene and tetrafluoroethylene or a blend of the polymers.

The present invention, however, is not limited thereto as long as the polymer material has superior dimensional stability. Through the introduction of the polymer material with superior dimensional stability, membrane/electrode interface stability can be ensured and long-term stability can be improved as detailed below.

The polymer material with superior dimensional stability is added in an amount of 0.01-50 weight %, preferably 0.01-20 weight %, and most preferably 0.05-10 weight %, based on the sulfonated polysulfoneketone copolymer. When the content exceeds 50 weight %, proton conductivity of the polymeric electrolyte membrane is decreased. And, when the content is below 0.01 weight %, interface stability is not improved. However, the aforesaid range is presented only as an exemplary preferred embodiment for carrying out the present invention, and the present invention is not necessarily limited thereto.

More specifically, of the aromatic sulfone repeating unit and the aromatic ketone repeating unit, the repeating unit having a sulfonic acid or sulfonate group accounts for 1 to 50 mol %.

The molar fraction of the repeating unit having a sulfonic acid or sulfonate group in the aromatic sulfone repeating unit and the aromatic ketone repeating unit is preferably 1-50 mol %, more preferably 30-50 mol %. When the molar fraction of the repeating unit is 1 mol % or larger, sufficient proton conductivity can be attained. And, when it is 50 mol % or smaller, structural stability can be ensured.

Preferably, in the sulfonated polysulfoneketone copolymer of the present invention, the aromatic sulfone repeating unit is represented by the following Chemical Formula 1, the aromatic ketone repeating unit is represented by the following Chemical Formula 2, the aromatic compound repeating unit which connects said repeating units with an ether linkage is represented by the following Chemical Formula 3, the aromatic sulfone repeating unit having a sulfonic acid or sulfonate group is represented by the following Chemical Formula 4, and the aromatic ketone repeating unit having a sulfonic acid or sulfonate group is represented by the following Chemical Formula 5:

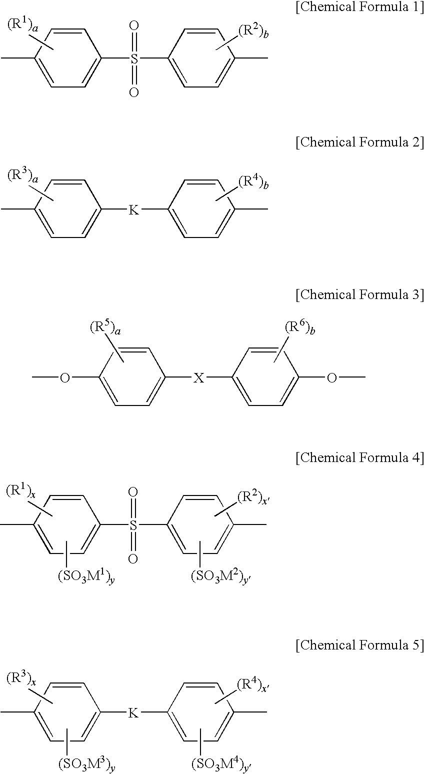

where each of M¹, M², M³ and M⁴ is independently selected from the group consisting of hydrogen, sodium, lithium and potassium,

K is a ketone selected from the group consisting of —CO—, —CO—CO— and

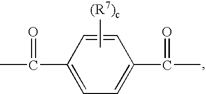

X is selected from the group consisting of —O—, —S—, —NH—, —SO₂—, —CO—, —C(CH₃)₂— and —C(CF₃)₂—,

each of R¹, R², R³, R⁴ and R⁵ is independently selected from the group consisting of a C₅-C₃₀ aromatic ring and a C₁-C₃₀ alkyl substituent containing a heteroatom selected from oxygen, nitrogen and sulfur,

each of a, b and c is independently an integer from 0 to 4,

each of x and x′ is independently an integer from 0 to 3,

each of y and y′ is independently an integer from 1 to 4, and

each of (x+y) and (x′+y′) is independently an integer from 1 to 4.

The above definitions of substituents apply to all the chemical formulas that follow.

Preferably, the polysulfoneketone copolymer of the present invention has a molecular structure represented by the following Chemical Formula 6 or Chemical Formula 7, for better ion conductivity and structural stability:

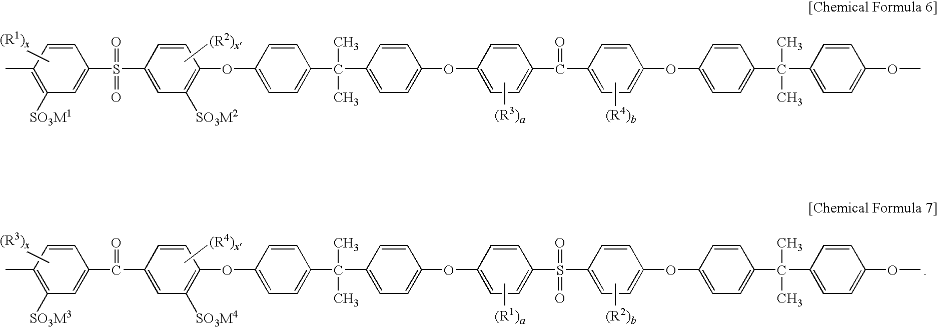

Preferably, the sulfonated polysulfoneketone copolymer of the present invention has a weight-average molecular weight from 10,000 to 200,000, more preferably from 30,000 to 150,000, for better mechanical strength and proton conductivity.

The sulfonated polysulfoneketone copolymer of the present invention may be a linear or branched polymer. More preferably, it is a branched polymer comprising a branching unit derived from a compound represented by the following Chemical Formulas 8 through 15.

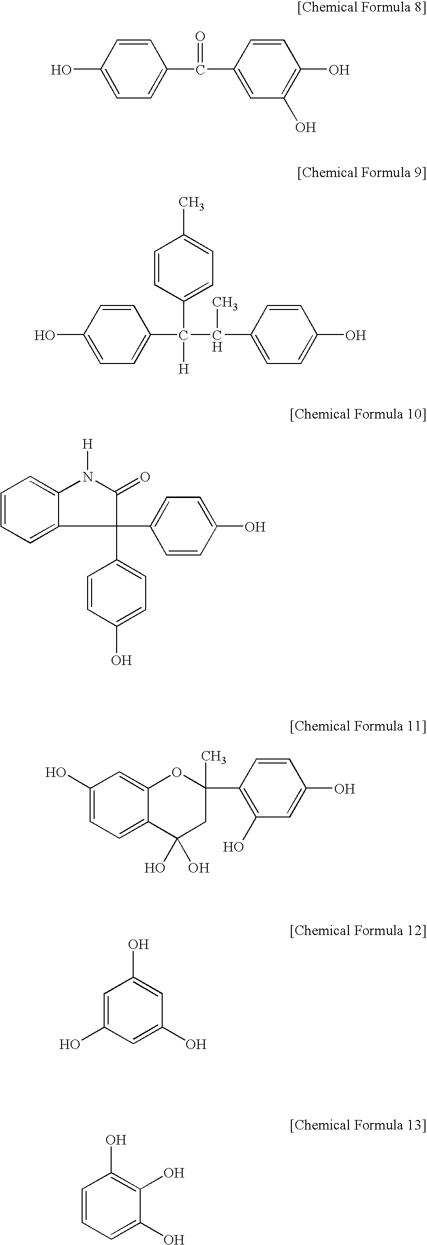

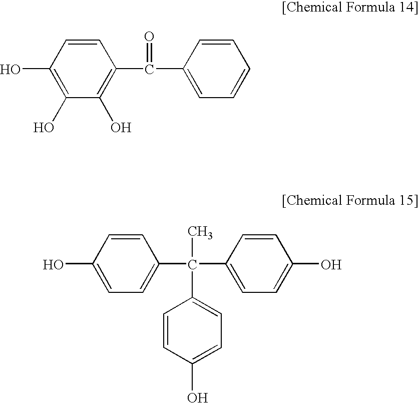

For the branched sulfonated polysulfoneketone copolymer of the present invention to have superior mechanical properties, it is preferred that the branching unit is comprised in an amount of at least 0.1 mol % based on the remaining aromatic compound repeating unit which connects the repeating units with an ether linkage. And, in order to prevent deterioration of processability caused by excessive cross-linking, it is preferred that the content is 1 mol % or smaller.

More preferably, the branched sulfonated polysulfoneketone copolymer of the present invention is a sulfonated polysulfoneketone copolymer having a molecular structure represented by the following Chemical Formula 16 or Chemical Formula 17.

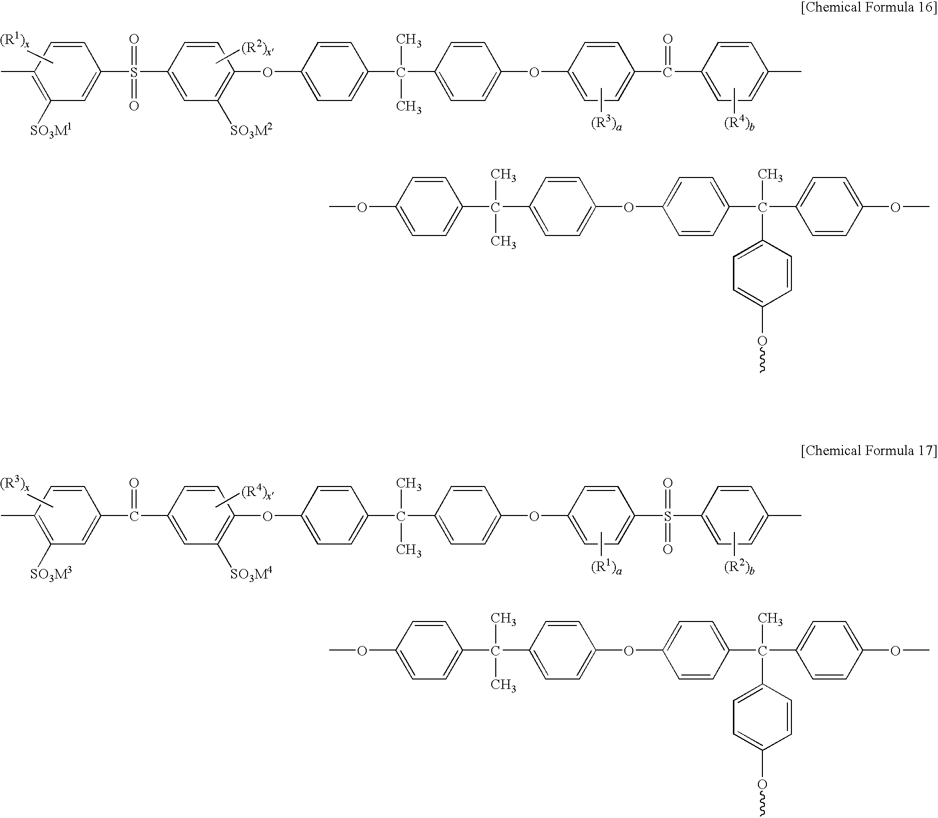

The sulfonated polysulfoneketone copolymer of the present invention can be used as a proton conducting polymeric electrolyte, particularly as a polymeric electrolyte membrane for a fuel cell.

The polymeric electrolyte comprising the sulfonated polysulfoneketone according to the present invention exhibits very high proton conductivity and significantly reduced methanol permeability.

Especially, the branched sulfonated polysulfoneketone copolymer has narrow spacing between the main chain and side chains and, therefore, has narrow passages. As a result, relatively large molecules cannot penetrate through the copolymer. Consequently, branched polysulfoneketone polymer according to the present invention exhibits superior thin film formability and superior stability against oxidation or reduction.

More specifically, the polymeric electrolyte membrane comprising the sulfonated polysulfoneketone copolymer of the present invention has a proton conductivity preferably at least 1.5×10⁻⁴ S/cm, more preferably from 1.5×10⁻⁴ to 1×10⁻¹ S/cm, and a methanol permeability not greater than 1.0×10⁻⁶ cm²/sec, more preferably from 1×10⁻⁹ to 1×10⁻⁶ cm²/sec. When the aforesaid proton conductivity and methanol permeability ranges are satisfied, the polymeric electrolyte can be sufficiently used for a direct-methanol fuel cell (DMFC).

In the present invention, the sulfonated polysulfoneketone copolymer comprises a monomer mixture comprising a sulfonated or unsulfonated aromatic sulfone monomer, a sulfonated or unsulfonated aromatic ketone monomer and a dihydroxy monomer.

The sulfonated polysulfoneketone copolymer of the present invention may be prepared by condensating monomer mixture comprising a sulfonated or unsulfonated aromatic sulfone monomer, a sulfonated or unsulfonated aromatic ketone monomer and a dihydroxy monomer in the presence of an organic solvent. Preferably, at least one of the aromatic sulfone monomer and the aromatic ketone monomer is a sulfonated one.

Specific examples of the monomer mixture may be:

a) a monomer mixture comprising an aromatic sulfone monomer, a sulfonated aromatic ketone monomer and an aromatic dihydroxy monomer;

b) a monomer mixture comprising an aromatic ketone monomer, a sulfonated aromatic sulfone monomer and an aromatic dihydroxy monomer;

c) a monomer mixture comprising a sulfonated aromatic ketone monomer, a sulfonated aromatic sulfone monomer and an aromatic dihydroxy monomer;

d) a monomer mixture comprising an aromatic sulfone monomer, aromatic ketone monomer, a sulfonated aromatic ketone monomer and an aromatic dihydroxy monomer;

e) a monomer mixture comprising an aromatic sulfone monomer, aromatic ketone monomer, a sulfonated aromatic sulfone monomer and an aromatic dihydroxy monomer; or

f) a monomer mixture comprising an aromatic sulfone monomer, an aromatic ketone monomer, a sulfonated aromatic ketone monomer, a sulfonated aromatic sulfone monomer and an aromatic dihydroxy monomer.

Preferably, in the monomer mixture, the aromatic sulfone monomer is represented by the following Chemical Formula 18, the aromatic ketone monomer is represented by the following Chemical Formula 19, the aromatic dihydroxy monomer is represented by the following Chemical Formula 20, the sulfonated aromatic sulfone monomer is represented by the following Chemical Formula 21, and the sulfonated aromatic ketone monomer is represented by the following Chemical Formula 22:

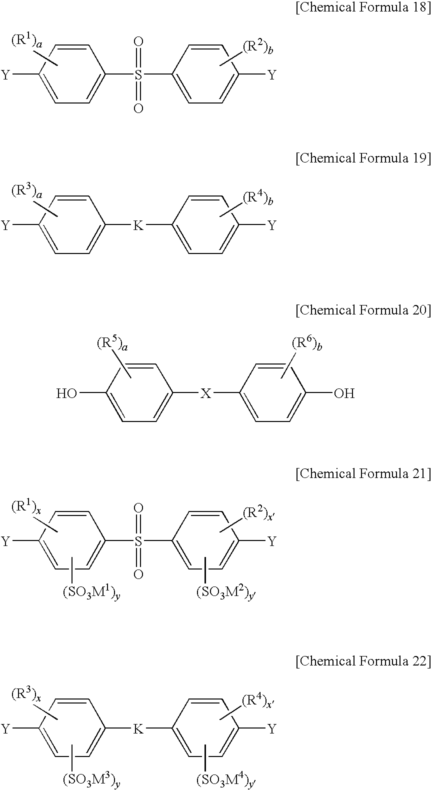

where

each of M¹, M², M³ and M⁴ is independently selected from the group consisting of hydrogen, sodium, lithium and potassium,

K is a ketone selected from the group consisting of —CO—, —CO—CO— and

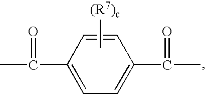

X is selected from the group consisting of —O—, —S—, —NH—, —SO₂—, —CO—, —C(CH₃)₂— and —C(CF₃)₂—,

each Y is independently a halogen atom selected from the group consisting of fluorine, chlorine, bromine and iodine,

each of R¹, R², R³, R⁴, R⁵, R⁶ and R⁷ is independently selected from the group consisting of a C₅-C₃₀ aromatic ring and a C₁-C₃₀ alkyl substituent containing a heteroatom selected from oxygen, nitrogen and sulfur,

each of a, b and c is independently an integer from 0 to 4,

each of x and x′ is independently an integer from 0 to 3,

each of y and y′ is independently an integer from 1 to 4, and

each of (x+y) and (x′+y′) is independently an integer from 1 to 4.

The condensation condition of the monomer mixture is the same as conventional etherification condition and is not particularly restricted in the present invention. Therefore, a detailed description thereof will be omitted.

Further, the branched sulfonated polysulfoneketone copolymer of the present invention may be prepared by carrying out polymerization after adding at least one polyfunctional monomer selected from the compounds represented by Chemical Formulas 8 through 15 to the monomer mixture of a) through f). Here, the addition amount of the polyfunctional monomer is determined by the content of the branching unit stated above.

In dry state, the polymeric electrolyte membrane of the present invention has a thickness from 5 to 200 μm, preferably from 5 to 100 μm, most preferably from 10 to 50 μm.

The present invention also provides a fuel cell comprising thus prepared polymeric electrolyte membrane.

### EXAMPLES

The following examples further illustrate the present invention. However, the following examples are provided for illustrative purposes only, and the scope of the present invention is not limited thereby.

### Example 1

### Preparation of Polymeric Electrolyte Membrane Comprising Sulfonated Polysulfoneketone Copolymer

Synthesis of Sulfonated Polysulfoneketone Copolymer

0.01 mol of bisphenol A, 0.005 mol of 4,4′-difluorobenzophenone and 0.005 mol of 3,3′-disodiumsufonyl-4,4′-difluorophenylsulfone were dissolved in 15 mL of N-methylpyrrolidone (NMP) in a 100 mL 3-bulb flask equipped with a Dean-Stark trap and a condenser. Then, 0.00002 mol of tris-4-hydroxyphenylethane (0.2 mol % based on bisphenol A) was added.

After adding K₂CO₃ (0.026 mol), heating to 70° C. and adding 10 mL of toluene, reflux reaction was carried out for 5 hours and the produced water was removed.

After the removal of water, toluene was removed by heating to 160° C. Then, reaction was further carried out at 160° C. for about 6 hours to prepare a sulfonated polysultoneketone copolymer.

Thus prepared sulfonated polysulfoneketone copolymer was precipitated in 200 mL of a mixture solution of water and methanol (3:7, v/v). Thus obtained solid had a viscosity of about 0.3-0.5 g/dL.

Preparation of Polymeric Electrolyte Membrane Comprising 0.5 Weight % of Polyvinylidene Fluoride (PVDF)

Thus obtained polymer was dissolved in a solvent to 10 weight %. Sulfonated polysulfoneketone copolymer was mixed with PVDF by introducing 0.5 weight % of PVDF based on the sulfonated polyetheretherketone polymer. After a homogeneous mixture was obtained, it was cast on a glass plate using a doctor blade. After drying in an oven of 50° C. for 72 hours followed by impregnation in distilled water, a blend membrane of the sulfonated polysulfoneketone copolymer and PVDF was obtained. After drying again in a vacuum oven of 100° C. for 24 hours, a blend membrane of the sulfonated polysulfoneketone copolymer and the PVDF was obtained.

### Example 2

### Preparation of Polymeric Electrolyte Membrane Comprising 1 Weight % of PVDF

A blend membrane was prepared in the same manner as in Example 1, except for introducing 1 weight % of PVDF based on the sulfonated polysulfoneketone copolymer.

### Example 3

### Preparation of Polymeric Electrolyte Membrane Comprising 1.5 Weight % of PVDF

A blend membrane was prepared in the same manner as in Example 1, except for introducing 1.5 weight % of PVDF based on the sulfonated polysulfoneketone copolymer.

### Example 4

### Preparation of Polymeric Electrolyte Membrane Comprising 2.5 Weight % of PVDF

A blend membrane was prepared in the same manner as in Example 1, except for introducing 2.5 weight % of PVDF based on the sulfonated polysulfoneketone copolymer.

### Example 5

### Preparation of Polymeric Electrolyte Membrane Comprising 5 Weight % of PVDF

A blend membrane was prepared in the same manner as in Example 1, except for introducing 5 weight % of PVDF based on the sulfonated polysulfoneketone copolymer.

### Example 6

### Preparation of Polymeric Electrolyte Membrane Comprising 0.006 Mol of 4,4′-Difluorobenzophenone

A sulfonated polysulfoneketone copolymer and a polymeric electrolyte membrane were prepared in the same manner as in Example 1, except for using 0.01 mol of bisphenol A, 0.006 mol of 4,4′-difluorobenzophenone, 0.004 mol of 3,3′-disodiumsufonyl-4,4′-difluorophenylsulfone and 0.00002 mol of tris-4-hydroxyphenylethane (0.2 mol % based on bisphenol A). A blend membrane was prepared in the same manner as in Examples 1 through 5.

### Example 7

### Preparation of Polymeric Electrolyte Membrane Comprising 0.007 Mol of 4,4′-Difluorobenzophenone

A sulfonated polysulfoneketone copolymer and a polymeric electrolyte membrane were prepared in the same manner as in Example 1, except for using 0.01 mol of bisphenol A, 0.007 mol of 4,4′-difluorobenzophenone, 0.003 mol of 3,3′-disodiumsufonyl-4,4′-difluorophenylsulfone and 0.00002 mol of tris-4-hydroxyphenylethane (0.2 mol % based on bisphenol A). A blend membrane was prepared in the same manner as in Examples 1 through 5.

### Example 8

### Preparation of Polymeric Electrolyte Membrane Comprising 0.008 Mol of 4,4′-Difluorobenzophenone

A sulfonated polysulfoneketone copolymer and a polymeric electrolyte membrane were prepared in the same manner as in Example 1, except for using 0.01 mol of bisphenol A, 0.008 mol of 4,4′-difluorobenzophenone, 0.002 mol of 3,3′-disodiumsufonyl-4,4′-difluorophenylsulfone and 0.00002 mol of tris-4-hydroxyphenylethane (0.2 mol % based on bisphenol A). A blend membrane was prepared in the same manner as in Examples 1 through 5.

### Example 9

### Preparation of Polymeric Electrolyte Membrane Comprising 0.006 Mol of 4,4′-Difluorophenylsulfone

A sulfonated polysulfoneketone copolymer and a polymeric electrolyte membrane were prepared in the same manner as in Example 1, except for using 0.01 mol of bisphenol A, 0.006 mol of 4,4′-difluorophenylsulfone, 0.004 mol of 3,3′-disodiumsufonyl-4,4′-difluorophenylsulfone and 0.00002 mol of tris-4-hydroxyphenylethane (0.2 mol % based on bisphenol A). A blend membrane was prepared in the same manner as in Examples 1 through 5.

### Example 10

### Preparation of Polymeric Electrolyte Membrane Comprising 0.007 Mol of 4,4′-Difluorophenylsulfone

A sulfonated polysulfoneketone copolymer and a polymeric electrolyte membrane were prepared in the same manner as in Example 1, except for using 0.01 mol of bisphenol A, 0.007 mol of 4,4′-difluorophenylsulfone, 0.003 mol of 3,3′-disodiumsufonyl-4,4′-difluorophenylsulfone and 0.00002 mol of tris-4-hydroxyphenylethane (0.2 mol % based on bisphenol A). A blend membrane was prepared in the same manner as in Examples 1 through 5.

### Comparative Examples

### Comparative Example 1

### Sulfonated Polyetheretherketone Polymeric Electrolyte Membrane

Sulfonated polyetheretherketone polymer manufactured by VICTREX was dissolved in a solvent to 10 weight % and cast on a glass plate using a doctor blade. After drying in an oven of 50° C. for 72 hours followed by impregnation in distilled water, a polymer membrane of the sulfonated polysulfoneketone polymer was obtained. After drying again in a vacuum oven of 50° C. for 24 hours, a sulfonated polyetheretherketone polymeric electrolyte membrane was obtained.

### Comparative Example 2

### Sulfonated Polyetheretherketone Polymeric Electrolyte Membrane

A polymeric electrolyte membrane was prepared in the same manner as in Example 1, without introducing PVDF.

### Test Examples

### Test Example 1

### Measurement of Proton Conductivity of Polymeric Electrolyte Membrane

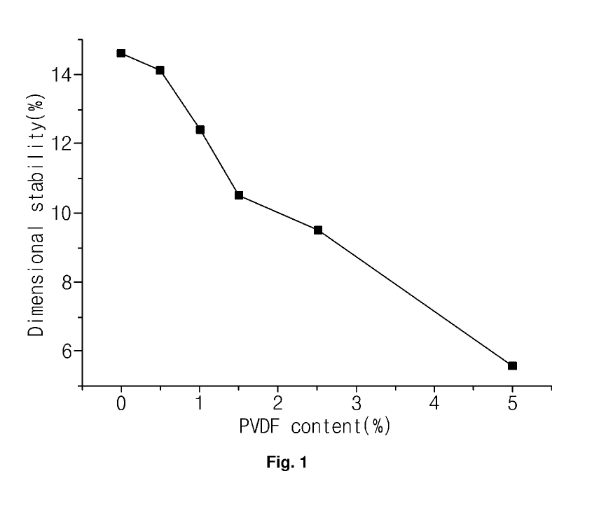

Proton conductivity of the polymeric electrolyte membranes prepared in Examples 1 through 5 and Comparative Example 2 was measured using an impedance spectrometer (SOLATRON). The result is depicted in FIG. 1. Impedance measurement was made while varying frequencies from 1 Hz to 1 MHz.

Proton conductivity was measured by in-plane mode. All the tests were carried out after completely saturating the samples with moisture.

As seen in FIG. 1, proton conductivity decreased as the content of PVDF in the sulfonated polymer increased. Without intending to limit the theory, this is because as the PVDF content increases, water content decreases and the proton transfer channel becomes discontinuous.

The decrease of ion conductivity seen in FIG. 1 is within an allowable range in the actual application of a polymeric electrolyte membrane.

### Test Example 2

### Measurement of Dimensional Stability of Polymeric Electrolyte Membrane

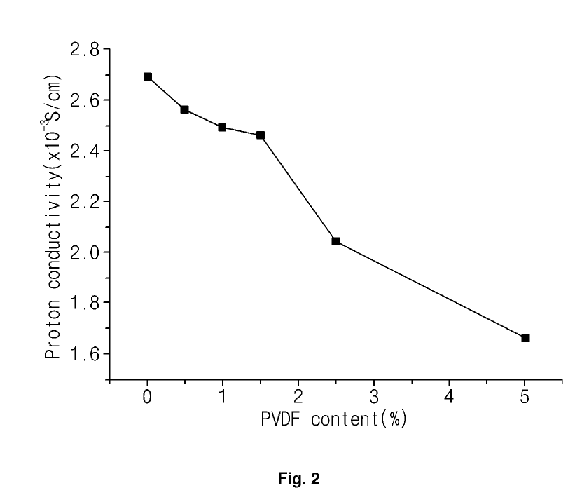

Dimensional stability of the polymeric electrolyte membranes prepared in Examples 1 through 5 was evaluated by measuring the change of dimension before and after hydration. The result is depicted in FIG. 2.

As seen in FIG. 2, dimensional stability was improved as the content of PVDF in the sulfonated polymer increased. The addition of the PVDF having superior dimensional stability in water to the sulfonated polymer with high water content resulted in the improvement of dimensional stability of the polymeric electrolyte membrane.

The enhanced dimensional stability leads to improved membrane/electrode interface stability.

### Test Example 3

### Comparison of Initial and Long-Term Stability of Polymeric Electrolyte Membrane

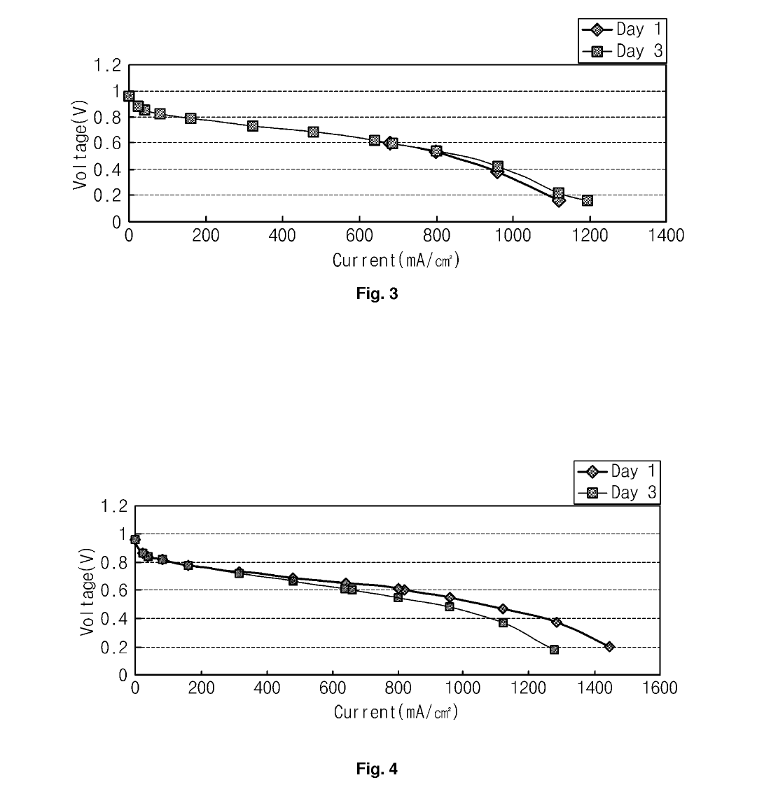

Initial and long-term stability of the polymeric electrolyte membranes prepared in Example 1 and Comparative Example 1 were compared. The result is depicted in FIG. 3 and FIG. 4.

The conventional hydrocarbon polymeric electrolyte membrane (Comparative Example 1) showed abruptly decreased cell performance on day 3. In particular, the day 3 cell performance decreased by 20 % with respect to the initial cell performance.

In contrast, the day 3 cell performance of Example 1 was comparable to the initial performance. It is because the initial and long-term stability was attained through enhanced membrane/electrode interface stability.

### Test Example 4

### Comparison of Initial and Long-Term Stability of Polymeric Electrolyte Membrane

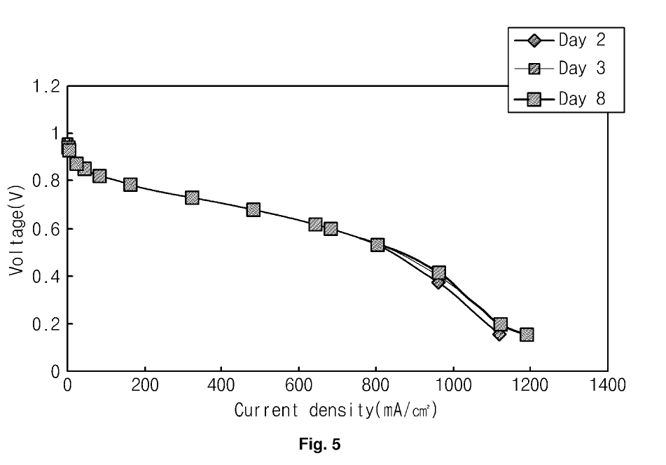

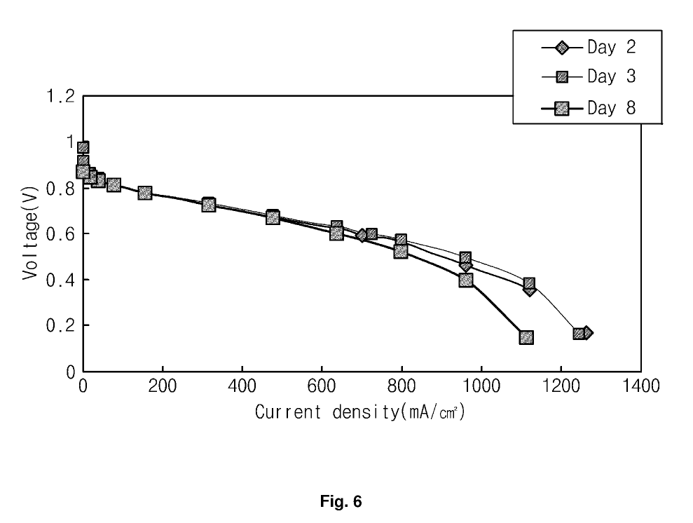

Initial and long-term stability of the polymeric electrolyte membranes prepared in Example 1 and Comparative Example 2 were compared. The result is depicted in FIG. 5 and FIG. 6.

The conventional hydrocarbon polymeric electrolyte membrane (Comparative Example 2) showed abruptly decreased cell performance on day 8. In particular, the day 8 cell performance decreased by 30 % with respect to the initial cell performance.

In contrast, the day 8 cell performance of Example 1 was comparable to the initial performance. It is because the initial and long-term stability was attained through enhanced membrane/electrode interface stability.

### Test Example 5

### Comparison of Cross-Sections by SEM

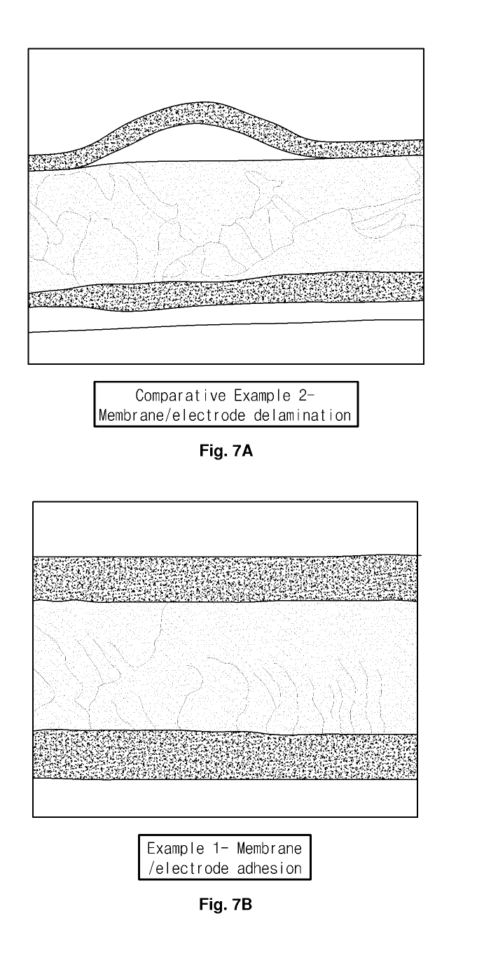

Cross-sectional SEM images of the polymeric electrolyte membranes prepared in Example 1 and Comparative Example 2 were taken (FIG. 7).

In Comparative Example 2, membrane/electrode delamination was observed, which resulted in increased interfacial resistance and, thereby, decreased cell performance.

On the other hand, Example 1 showed well-maintained membrane/electrode interface adhesion, which contributed to improved long-term stability.

Although the preferred embodiments of the present invention have been disclosed for illustrative purposes, those skilled in the art will appreciate that various modifications, additions and substitutions are possible, without departing from the scope and spirit of the invention as disclosed in the accompanying drawings.

1. A polymeric electrolyte membrane comprising:
(a) a sulfonated polysulfoneketone copolymer comprising an aromatic sulfone repeating unit, an aromatic ketone repeating unit and an aromatic compound repeating unit which connects said repeating units with an ether linkage, wherein the aromatic sulfone repeating unit, the aromatic ketone repeating unit or both have a sulfonic acid or sulfonate substituent; and
(b) one or more polymers each comprising a monomer selected from the group consisting of vinylidene fluoride, hexafluoropropylene, trifluoroethylene and tetrafluoroethylene.

2. The polymeric electrolyte membrane as set forth in claim 1, wherein the polymer is comprised in the amount of 0.01-50 weight % based on the sulfonated polysulfoneketone copolymer.

3. The polymeric electrolyte membrane as set forth in claim 1, wherein 1 to 50mol % of the aromatic sulfone repeating unit and the aromatic ketone repeating unit has the sulfonic acid or sulfonate substituent.

4. The polymeric electrolyte membrane as set forth in claim 1, wherein the aromatic sulfone repeating unit is represented by the following Chemical Formula 1, the aromatic ketone repeating unit is represented by the following Chemical Formula 2, the aromatic compound repeating unit which connects said repeating units with an ether linkage is represented by the following Chemical Formula 3, the aromatic sulfone repeating unit having the sulfonic acid or sulfonate substituent is represented by the following Chemical Formula 4, and the aromatic ketone repeating unit having the sulfonic acid or sulfonate substituent is represented by the following Chemical Formula 5: 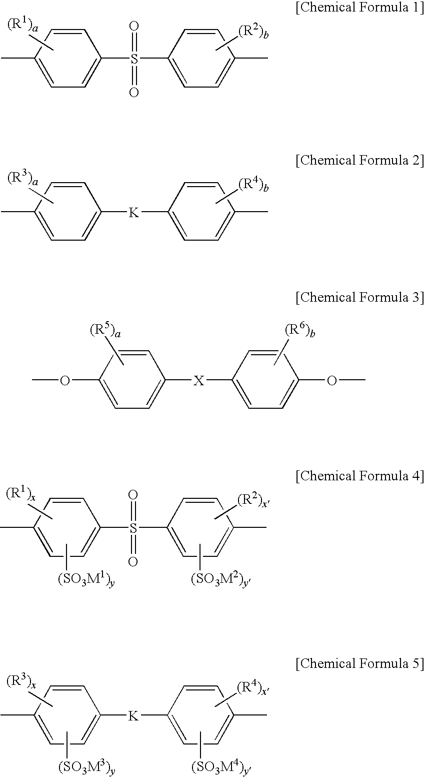
where each of M¹, M², M³ and M⁴ is independently selected from the group consisting of hydrogen, sodium, lithium and potassium, K is a ketone selected from the group consisting of —CO—, —CO—CO— and 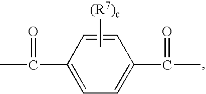
X is one selected from the group consisting of —O—, —S—, —NH—, —SO₂—, —CO—, —C(CH₃)₂— and —C(CF₃)₂—,
each of R¹, R², R³, R⁴ and R⁵ is independently selected from the group consisting of a C₅-C₃₀ aromatic ring and a C₁-C₃₀ alkyl substituent containing a heteroatom selected from oxygen, nitrogen and sulfur,
each of a, b and c is independently an integer from 0 to 4,
each of x and x′ is independently an integer from 0 to 3,
each of y and y′ is independently an integer from 1 to 4, and
each of (x+y) and (x′+y′) is independently an integer from 1 to 4.

5. The polymeric electrolyte membrane as set forth in claim 1, wherein the polysulfoneketone copolymer has a molecular structure represented by the following Chemical Formula 6 or Chemical Formula 7: 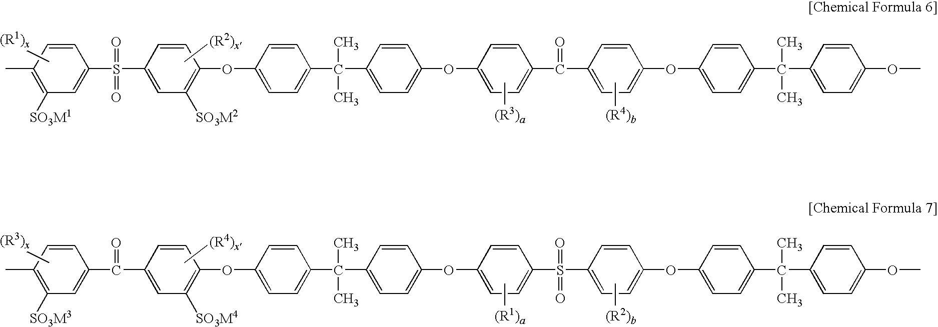
where
each of R¹, R², R³ and R⁴ is independently selected from the group consisting of a C₅-C₃₀ aromatic ring and a C₁-C₃₀ alkyl substituent containing a heteroatom selected from oxygen, nitrogen and sulfur,
each of M₁, M², M³ and M⁴ is independently selected from the group consisting of hydrogen, sodium, lithium and potassium,
each of a and b is independently an integer from 0 to 4, and
each of x and x′ is independently an integer from 0 to 3.

6. The polymeric electrolyte membrane as set forth in claim 1, wherein the polysulfoneketone copolymer further comprising a branching unit derived from at least one polyfunctional monomer selected from the group of the compounds represented by the following Chemical Formulas 8 through 15:

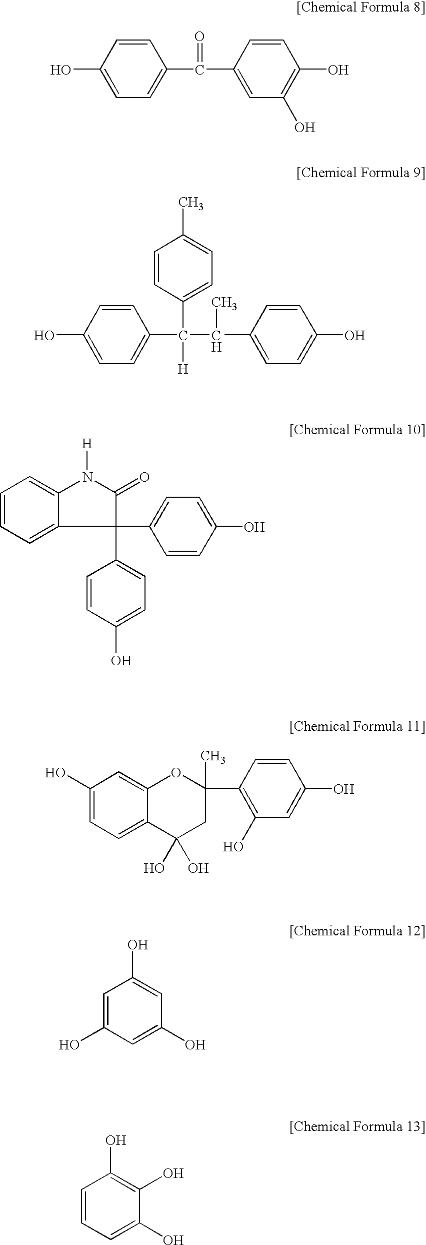

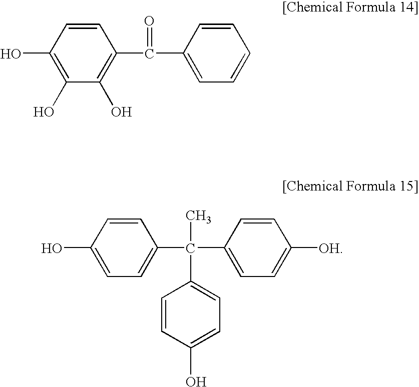

7. The polymeric electrolyte membrane as set forth in claim 6, wherein the branching unit is comprised in an amount of 0.1-1 mol % based on the aromatic compound repeating unit which connects said repeating units with an ether linkage.

8. The polymeric electrolyte membrane as set forth in claim 6, wherein the branched polysulfoneketone copolymer has a molecular structure represented by the following Chemical Formula 16 or Chemical Formula 17: 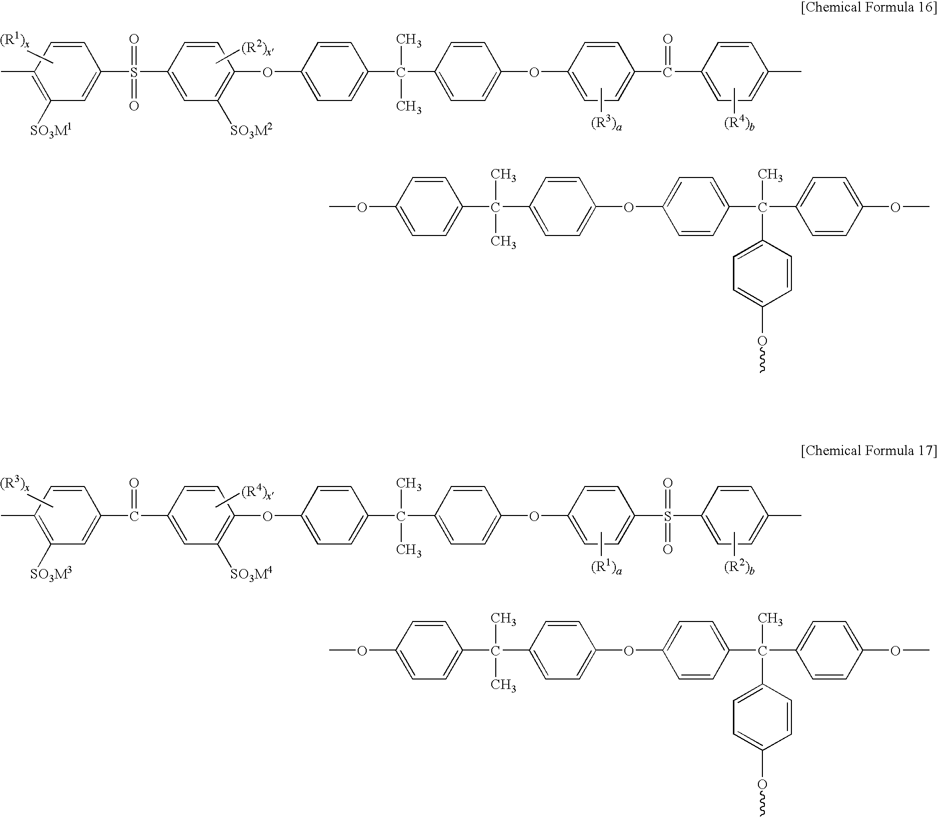
where
each of R¹, R², R³ and R⁴ is independently selected from the group consisting of a C₅-C₃₀ aromatic ring and a C₁-C₃₀ alkyl substituent containing a heteroatom selected from oxygen, nitrogen and sulfur,
each of M¹, M², M³ and M⁴ is independently selected from the group consisting of hydrogen, sodium, lithium and potassium,
each of a and b is independently an integer from 0 to 4, and
each of x and x′ is independently an integer from 0 to 3.

9. The polymeric electrolyte membrane as set forth in claim 1, wherein the sulfonated polysulfoneketone copolymer comprises a monomer mixture comprising a sulfonated or unsulfonated aromatic sulfone monomer, a sulfonated or unsulfonated aromatic ketone monomer and a dihydroxy monomer.

10. The polymeric electrolyte membrane as set forth in claim 9, wherein the monomer mixture is:
a) a monomer mixture comprising an aromatic sulfone monomer, a sulfonated aromatic ketone monomer and an aromatic dihydroxy monomer;
b) a monomer mixture comprising an aromatic ketone monomer, a sulfonated aromatic sulfone monomer and an aromatic dihydroxy monomer;
c) a monomer mixture comprising a sulfonated aromatic ketone monomer, a sulfonated aromatic sulfone monomer and an aromatic dihydroxy monomer;
d) a monomer mixture comprising an aromatic sulfone monomer, aromatic ketone monomer, a sulfonated aromatic ketone monomer and an aromatic dihydroxy monomer;
e) a monomer mixture comprising an aromatic sulfone monomer, aromatic ketone monomer, a sulfonated aromatic sulfone monomer and an aromatic dihydroxy monomer; or
f) a monomer mixture comprising an aromatic sulfone monomer, an aromatic ketone monomer, a sulfonated aromatic ketone monomer, a sulfonated aromatic sulfone monomer and an aromatic dihydroxy monomer.

11. The polymeric electrolyte membrane as set forth in claim 10, wherein the aromatic sulfone monomer is represented by the following Chemical Formula 18, the aromatic ketone monomer is represented by the following Chemical Formula 19, the aromatic dihydroxy monomer is represented by the following Chemical Formula 20, the sulfonated aromatic sulfone monomer is represented by the following Chemical Formula 21, and the sulfonated aromatic ketone monomer is represented by the following Chemical Formula 22: 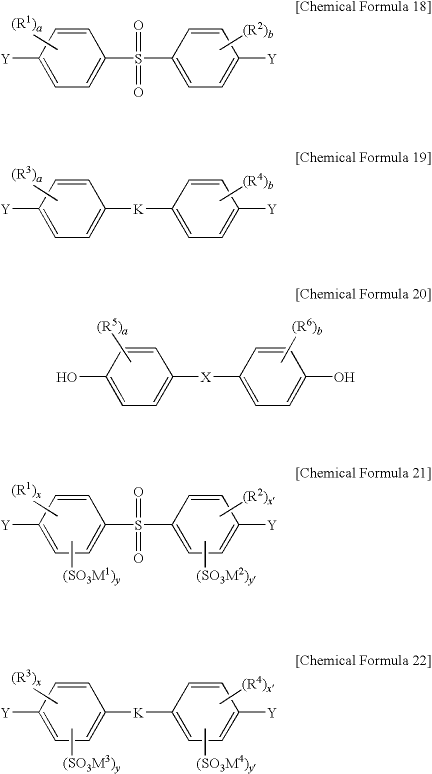
where
each of M¹, M², M³ and M⁴ is independently selected from the group consisting of hydrogen, sodium, lithium and potassium,
K is a ketone selected from the group consisting of —CO—, —CO—CO— and 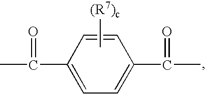
X is selected from the group consisting of —O—, —S—, —NH—, —SO₂—, —CO—, —C(CH₃)₂— and —C(CF₃)₂—,
each Y is independently one halogen atom selected from the group consisting of fluorine, chlorine, bromine and iodine,
each of R¹, R², R³, R⁴, R⁵, R⁶ and R⁷ is independently selected from the group consisting of a C₅-C₃₀ aromatic ring and a C₁-C₃₀ alkyl substituent containing a heteroatom selected from oxygen, nitrogen and sulfur,
each of a, b and c is independently an integer from 0 to 4,
each of x and x′ is independently an integer from 0 to 3,
each of y and y′ is independently an integer from 1 to 4, and
each of (x+y) and (x′+y′) is independently an integer from 1 to 4.
